(19) United States
(12) Patent Application Publication
(10) Pub. No.: US 2022/0241689 A1
(43) Pub. Date: Aug. 4, 2022

(54) Game Character Rendering Method And Apparatus, Electronic Device, And Computer-Readable Medium

(71) Applicant: Xiamen Yaji Software Co., Ltd, Xiamen, Fujian (CN)

(72) Inventors: Weiliang Wang, Xiamen, Fujian (CN); Yunxiao Wu, Xiamen, Fujian (CN); Shun Lin, Xiamen, Fujian (CN)

(73) Assignee: Xiamen Yaji Software Co., Ltd, Xiamen, Fujian (CN)

(21) Appl. No.: 17/626,685

(22) PCT Filed: Aug. 11, 2020
(86) PCT No.: PCT/CN2020/108494

§ 371 Date: Jan. 12, 2022

(30) Foreign Application Priority Data
Jul. 17, 2019 (CN) 201910647333.6

(51) Int. Cl. A63F 13/52

(52) U.S. Cl. CPC A63F 13/52

(57) ABSTRACT

Embodiments of the present disclosure provide a game character rendering method and apparatus, an electronic device, and a computer-readable medium. The method includes: obtaining a mesh model corresponding to each part of the game character, when a triggering operation for changing the game character's equipment is detected; determining, according to the triggering operation for the changing equipment, equipment texture and equipment data corresponding to each part; obtaining a combined game character, by combining mesh models and equipment textures corresponding to respective parts based on the equipment data; and rendering the combined game character. The present disclose may recombine parts obtained after splitting a mesh model of a game character during equipment change of the character, and then perform integral rendering, such that only one rendering is required, and the efficiency of rendering is improved.

### CROSS-REFERENCES TO RELATED APPLICATIONS

The present application is a national phase entry under 35 U.S.C. § 371 of International Application No. PCT/CN2020/108494, filed Aug. 11, 2020, which claims the priority of Chinese patent application No. 201910647333.6 filed with the China National Intellectual Property Administration on Jul. 17, 2019, entitled “Game Character Rendering Method and Apparatus, Electronic Device, and Computer Readable Medium”, of which the entire contents are incorporated herein by reference.

### TECHNICAL FIELD

The present disclosure relates to the field of computer technologies, and specifically, the present disclosure relates to a game character rendering method and apparatus, electronic device, and computer-readable medium.

### BACKGROUND

With the developments of computer technologies, game controlled by computer programs for puzzle or entertainment are increasingly popular. The contents of the game are becoming richer and more diverse, the plots of the game are becoming more and more complicated, and the images of the game are becoming more and more realistic. The game contains game scenes and multiple characters, and the visualization of the game scenes and characters are realized by computer software.

Changing a character's equipment often occurs in the game. Changing the character's equipment refers to the changes in the equipment worn by the characters in the game. For example, when a game character who has worn a set of armor picks up a new set of armor, the game character will wear the new set of armor, and the appearances of the two sets are different. The process of changing the character's equipment involves the steps of re-rendering the character after changing the character's equipment. A character has many parts, such as head, legs, body, hands, or the like. In the prior art, when rendering a character on whom equipment change occurs is to be performed, all parts requiring an equipment change are rendered one by one. Due to the large number of the variety and quantity of parts requiring the equipment change, efficiency of rendering is low.

### SUMMARY

The present disclosure provides a game character rendering method and apparatus, electronic device, and computer readable medium, which may at least solve the problem existing in the prior art.

The specific technical solutions provided by the embodiments of the present disclosure are as follows:

According to a first aspect of the embodiments of the present disclosure, the present disclosure provides a game character rendering method. The method includes:

obtaining a mesh model corresponding to each part of the game character, when a triggering operation for changing the game character's equipment is detected;

determining, according to the triggering operation for the changing equipment, equipment texture and equipment data corresponding to each part;

obtaining a combined game character, by combining mesh models and equipment textures corresponding to respective parts based on the equipment data; and

rendering the combined game character.

In an implementation, the obtaining the mesh model corresponding to each part of the game character includes:

obtaining a mesh model corresponding to each part, by dividing the mesh model corresponding to the game character according to each part.

In an implementation, when the combined game character is obtained, the method further includes:

obtaining bone structure information and bone dynamic information of the game character; and

determining a combined dynamic game character based on the bone structure information and the bone dynamic information.

In an implementation, rendering the combined game character includes:

rendering the combined dynamic game character.

In an implementation, the equipment data comprises size and offset of equipment texture corresponding to each part; and

obtaining a combined game character, by combining the mesh models and the equipment textures corresponding to the respective parts based on the equipment data comprises:

combining the mesh models corresponding to the respective parts,

combining, according to the size and offset of the equipment textures, the equipment textures corresponding to the respective parts, and

combining the combined mesh models and the combined equipment textures.

In an implementation, a format of the mesh model corresponding to each part comprises one of Gltf format and fbx format.

In an implementation, a format of the bone structure information and the bone dynamic information comprises one of Gltf format and fbx format.

According to a second aspect of the embodiments of the present disclosure, the present disclosure provides a game character rendering apparatus, which includes:

an obtaining module configured for obtaining a mesh model corresponding to each part of the game character when a triggering operation for changing the game character's equipment is detected;

a determining module configured for determining, according to the triggering operation for the changing equipment, equipment texture and equipment data corresponding to each part;

a combining module configured for combining the mesh models and the equipment textures corresponding to the respective parts based on the equipment data to obtain a combined game character; and

a rendering module configured for rendering the combined game character.

In an implementation, the obtaining module is also configured for:

obtaining a mesh model corresponding to each part, by dividing the mesh model corresponding to the game character according to each part.

In an implementation, the obtaining module is also configured for:

obtaining bone structure information and bone dynamic information of the game character; and

determining a combined dynamic game character based on the bone structure information and the bone dynamic information.

In an implementation, the rendering module is also configured for:

rendering the combined dynamic game character.

In an implementation, the equipment data comprises size and offset of equipment texture corresponding to each part; and

combining the mesh models and the equipment textures corresponding to the respective parts based on the equipment data to obtain a combined game character comprises:

combining the mesh models corresponding to the respective parts,

combining, according to the size and offset of the equipment textures, the equipment textures corresponding to the respective parts, and

combining the combined mesh models and the combined equipment textures.

In an implementation, a format of the mesh model corresponding to each part comprises one of Gltf format and fbx format.

In an implementation, a format of the bone structure information and the bone dynamic information comprises one of Gltf format and fbx format.

According to a third aspect of the embodiments of the present disclosure, the present disclosure provides an electronic device, including:

one or more processors; and

a memory configured to store one or more application programs;

wherein, the one or more application programs are configured to, when executed by the one or more processors, implement the game character rendering method according to any implementation of the first or second aspect.

According to a fourth aspect of the embodiments of the present disclosure, the present disclosure provides a computer-readable medium on which a computer program is stored. The program is configured when executed by a processor, to implement any implementation of the first or second aspect.

### BRIEF DESCRIPTION OF THE DRAWINGS

In order to illustrate the technical solutions more clearly in the embodiments of the present disclosure, the following briefly introduces the drawings required for describing the embodiments of the present disclosure.

FIG. 1 is a schematic flowchart of a game character rending method according to an embodiment of the present disclosure.

FIG. 2 is a schematic structural diagram of a game character rendering apparatus according to an embodiment of the present disclosure.

FIG. 3 is a schematic structural diagram of an electronic device according to an embodiment of the present disclosure.

### DETAILED DESCRIPTION

The embodiments of the present disclosure are described in detail below. Examples of the embodiments are shown in the accompanying drawings, wherein the same or similar reference numerals indicate the same or similar elements or elements with the same or similar functions. The embodiments described below with reference to the drawings are exemplary, and are only used to explain the present disclosure, and cannot be construed as a limitation to the present disclosure.

Those skilled in the art can understand that, unless specifically stated otherwise, the singular forms “a”, “said” and “the” used herein may also include plural forms. It should be further understood that the term “comprising” used in the specification of the present disclosure refers to the presence of the described features, integers, steps, operations, elements and/or parts, but does not exclude the presence or addition of one or more other features, integers, steps, operations, elements, parts, and/or combinations thereof. It should be understood that when we refer to an element as being “connected” or “coupled” to another element, it may be directly connected or coupled to the other element, or intervening elements may also be present. In addition, “connected” or “coupled” used herein may include wireless connection or wireless coupling. The term “and/or” as used herein includes all or any unit and all combinations of one or more associated listed items.

The executive body of the technical solutions of the present disclosure is computer equipment, including but not limited to servers, personal computers, notebook computers, tablet computers, smart phones, or the like. Computer equipment includes user equipment and network equipment. Here, the user equipment includes but is not limited to computers, smart phones, PDAs, or the like. The network equipment includes, but is not limited to, a single network server, a server group composed of multiple network servers, or a cloud based on cloud computing and composed of many computers or network servers. Here, cloud computing is a kind of distributed computing, and is a super virtual computer composed of a group of loosely coupled computer sets. Here, the computer equipment may run alone to implement the present disclosure or it can access the network and implement the present disclosure through interactive operations with other computer equipment in the network. Here, the network where the computer equipment is located includes but is not limited to the Internet, wide area network, metropolitan area network, local area network, VPN network, etc.

In order to make the object, technical solutions, and advantages of the present disclosure clearer, the implementations of the present disclosure will be further described in detail below in conjunction with the accompanying drawings.

The technical solutions of the present disclosure and how the technical solutions of the present disclosure solve the above-mentioned technical problem will be described in detail below with specific embodiments. The following specific embodiments may be combined with each other, and the same or similar concepts or processes may not be repeated in some embodiments. The embodiments of the present disclosure will be described below in conjunction with the accompanying drawings.

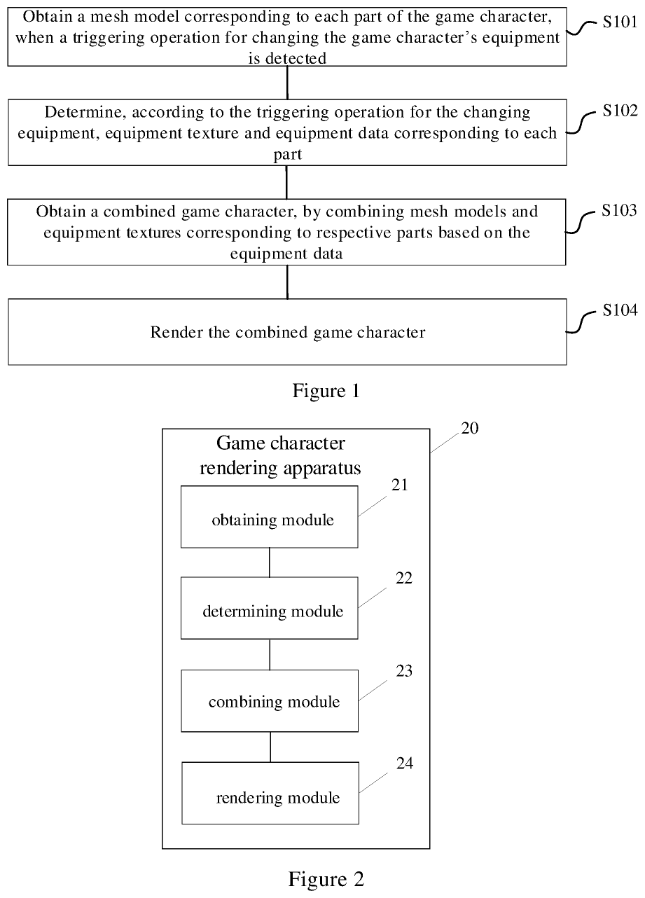

A game character rendering method is provided in the embodiments of the present disclosure. As shown in FIG. 1, the method includes the following steps.

Step S101, when a triggering operation for changing a game character's equipment is detected, a mesh model corresponding to each part of the game character is obtained.

Step S102, according to the triggering operation for the changing equipment, equipment texture corresponding to each part and equipment data corresponding to each part are determined. According to the triggering operation for the changing equipment input from a user terminal, equipment texture and equipment data corresponding to each part of the mesh model are determined, and the equipment data includes the size of the equipment texture of each part, and the offset of the equipment texture of each part in the overall map.

Step S103, a combined game character is obtained by combining the mesh models and equipment textures corresponding to the respective parts based on the equipment data.

The mesh models corresponding to respective parts are combined into an overall mesh model based on the equipment data, the equipment texture corresponding to each part are combined as a whole to get the overall map after changing equipment, and the overall mesh model and the overall maps are combined to get the combined game character.

It should be noted that there is no strict order during execution for the steps of combining the mesh model corresponding to each part and the steps of combining the maps corresponding to each part.

Step S104, the combined game character is rendered.

Only one overall rendering of the combined game character is required, and each part is no longer required to be rendered separately, thereby improving the efficiency of rendering.

The embodiments of the present disclosure provide a method of rendering game character. When a triggering operation for changing a game character's equipment is detected, a mesh model corresponding to each part of the game character is obtained. According to the triggering operation for the changing equipment, equipment texture and equipment data corresponding to each part are determined. Based on the equipment data, the mesh models and equipment textures corresponding to the respective parts are combined to obtain a combined game character. The combined game character is rendered. In the present disclosure, the various parts of the character are divided in advance by means of a mesh model. When changing the equipment of the character, the mesh models and the equipment texture of the divided parts of the game character are re-combined, and then the overall rendering is performed. Therefore, the rendering is performed merely once, rather than rendering each part separately, which improves the efficiency of rendering.

The above-mentioned solutions of the embodiments of the present disclosure will be specifically described below.

Step S101, when a triggering operation for changing a game character's equipment is detected, a mesh model corresponding to each part of the game character is obtained.

Specifically, when a user obtains new game equipment in playing of a game, an operation of changing equipment will be triggered. When the triggering operation of changing a user's equipment is detected, the mesh model of each part may be obtained according to the overall mesh model of the game character. Here, the mesh model of the game character is generated by modeling software, such as 3DMAX, Photoshop, body paint and MAYA. In an example, the mesh model of each part may be pre-stored, and directly exported or called when needed. In another example, an overall mesh model may be divided according to a preset marked position according to the trigger operation for the changing equipment.

In an implementation, obtaining the mesh model corresponding to each part of the game character includes: dividing, by the parts, the mesh model corresponding to the game character to obtain a mesh model corresponding to each part.

In practical applications, when the user's triggering operation for changing a game character's equipment is detected, the overall mesh model of the game character is divided into mesh models corresponding to respective parts, such as the head, legs, body, hands, etc., to get the mesh model corresponding to each part. The mesh model of each part may be exported through the exporter of the modeling software.

In an implementation, a format of the mesh model corresponding to each part includes: Gltf format or fbx format.

In practical applications, when the mesh model for each part is exported by the exporter of the modeling software, the mesh model in an intermediate format, such as Gltf format, fbx format, is exported. The purpose of exporting in an intermediate format is to facilitate subsequent use of the editor to process the exported mesh model.

Step S102, according to the triggering operation for the changing equipment, equipment texture and equipment data corresponding to each part are determined.

Specifically, according to a user identification corresponding to the triggering operation for the changing equipment, the equipment texture of each part in a user configuration information (for example, helmet, armor, etc.), as well as the size of the equipment texture corresponding to each part and the offset of the equipment texture in the overall map are inquired.

Step S103, a combined game character is obtained by combining the mesh models and equipment textures corresponding to the respective parts based on the equipment data.

In an implementation, combining the mesh models and the equipment textures corresponding to respective parts, based on the size and offset of the equipment texture corresponding to each part, includes: combining the mesh model corresponding to each part, and according to the size and offset of the equipment texture, combining the equipment texture corresponding to each part, and combining the combined mesh models and combined equipment texture.

In practical applications, according to a preset combination information, the mesh models corresponding to respective parts are combined to obtain the overall mesh model of the game character. According to the size and offset of the equipment texture, the equipment texture corresponding to each part is combined to obtain a complete map of the game character after changing equipment. The complete mesh model and the complete equipment texture are combined to get the game character after changing equipment.

In an implementation, when the combined game character is obtained, the method further includes: obtaining bone structure information and bone dynamic information of the game character; and determining a combined dynamic game character based on the bone structure information and the bone dynamic information.

In practical applications, the bone structure information and bone dynamic information of the game character are generated by modeling software, such as 3DMAX, Photoshop, bodypaint, MAYA, etc. The bone structure information and bone dynamic information may be exported through the exporter of the modeling software.

The determination of a dynamic game character first needs to associate the mesh model with the bones, and bind the mesh model to the bones through skinning technology, so that the bones drives the mesh model to produce reasonable motions. When an association relationship between the bone structure information and the mesh model is established, according to bone dynamic information, for example, the displacement of bones in each frame of the picture, the posture of the mesh model in each frame and position change of the map corresponding to the mesh model in each frame of the picture are determined, to obtain the dynamic game character.

In an implementation, the format of bone structure information and bone dynamic information includes: Gltf format or fbx format.

In practical applications, when the bone structure information and the bone dynamic information are exported by using the exporter of the modeling software, the bone structure information and the bone dynamic information in the intermediate format, such as Gltf format, fbx format, etc., are exported. Exporting the bone structure information and the bone dynamic information in the intermediate format helps subsequent processing with the editor.

Step S104, the combined game character is rendered.

Specifically, the final effect image or animation may be made by software itself, such as 3DS MAX, MAYA or auxiliary software, such as lightscape, vray, etc. The combined game character, animation, shadow, special effects and other effects are calculated in real time through a rendering engine, and are displayed on the screen, so as to realize the rendering of the game character after changing equipment.

In an implementation, rendering the combined game character includes: rendering the combined dynamic game character.

In practical applications, when the game character is dynamic, each frame of a static game character is rendered, and when the display for the dynamic game character is performed, the picture presents a rendering effect of the dynamic game character.

Based on the same principle as the method shown in FIG. 1, a game character rendering apparatus 20 is provided in embodiment of the present disclosure. As shown in FIG. 2, the game character rendering apparatus 20 includes an obtaining module 21, a determining module 22, a combining module 23 and a rendering module 24.

The obtaining module 21 is configured for obtaining a mesh model corresponding to each part of the game character when a triggering operation for changing a game character's equipment is detected.

The determining module 22 is configured for determining, according to the triggering operation for the changing equipment, equipment texture and equipment data corresponding to each part.

The combining module 23 is configured for combining the mesh models and equipment textures corresponding to the respective parts based on the equipment data to obtain a combined game character.

The rendering module 24 is configured for rendering the combined game character.

In an implementation, the obtaining module 21 is further configured for:

obtaining a mesh model corresponding to each part, by dividing the mesh model corresponding to the game character according to each part.

In an implementation, the obtaining module 21 is further configured for:

when the combined game character is obtained,

obtaining bone structure information and bone dynamic information of the game character; and

determining a combined dynamic game character based on the bone structure information and the bone dynamic information.

In an implementation, the rendering module 24 is further configured for:

rendering the combined dynamic game character.

In an implementation, the equipment data comprises size and offset of equipment texture corresponding to each part. The combining module 23 is also configured for: combining the mesh models corresponding to the respective parts, combining, according to the size and offset of the equipment textures, the equipment textures corresponding to the respective parts, and combining the combined mesh models and the combined equipment textures.

In an implementation, a format of the mesh model corresponding to each part comprises one of Gltf format and fbx format.

In an implementation, a format of the bone structure information and the bone dynamic information comprises one of Gltf format and fbx format.

The game character rendering apparatus of the embodiment of the present disclosure may execute the game character rendering method provided by the embodiments of the present disclosure, and their implementation principle is similar. The steps performed by the modules in the game character rendering apparatus in the embodiments of the present disclosure correspond to the steps in the game character rendering method in the embodiments of the present disclosure. For the detailed function description of each module of the game character rendering apparatus, please refer to the description of the corresponding game character rendering method shown in the foregoing text, which will not be repeated here.

The present disclosure provides a game character rendering apparatus. A mesh model corresponding to each part of the game character is obtained, when a triggering operation for changing the game character's equipment is detected. According to the triggering operation for the changing equipment, equipment texture and equipment data corresponding to each part are determined. A combined game character is obtained, by combining mesh models and equipment textures corresponding to respective parts based on the equipment data. The combined game character is rendered. The disclosure may divide the various parts of the character in advance by means of a mesh model. When changing the equipment of the character, the mesh models and the equipment texture of the divided parts of the game character are re-combined, and then the overall rendering is performed. Therefore, rendering is merely performed once without rendering separately for each part, which improves the rendering efficiency.

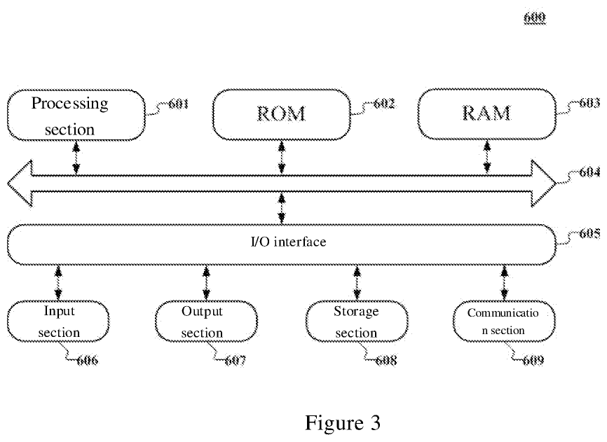

FIG. 3 illustrates a schematic structural diagram for implementing an electronic device 600 in the embodiments of the present disclosure. The executive body of the technical solutions of the embodiments of the present disclosure is computer equipment, which may include, but is not limited to, mobile terminals including servers, mobile phones, laptops, digital broadcast receivers, PDAs (personal digital assistants), PADs (tablets), and PMPs (portable multimedia players), in-vehicle terminals (for example, in-vehicle navigation terminals), and fixed terminals such as digital TVs, desktop computers, etc. The electronic device shown in FIG. 3 is only an example, and should not cause any limitation to the function and scope of use of the embodiments of the present disclosure.

The electronic device includes a memory and a processor. Here, the processor may be referred to as a processing device 601 described below, and the memory may include at least one of a read-only memory (ROM) 602, a random-access memory (RAM) 603, and a storage section 608, and it is specifically as follows:

As shown in FIG. 3, the electronic device 600 may include a processing section (such as a central processing unit, a graphics processor, etc.) 601, which may perform various appropriate actions and processing, according to a program stored in a read-only memory (ROM) 602, or a program loaded from the storage section 608 to the random-access memory (RAM) 603. In the RAM 603, various programs and data required for the operation of the electronic device 600 are also stored. The processing section 601, the ROM 602, and the RAM 603 are connected to each other through a bus 604. An input/output (I/O) interface 605 is also connected to the bus 604. Generally, the following sections may be connected to the I/O interface 605: an input section 606, an output section 607, a storage section 608 and a communication section 609. The input section 606 includes, for example, an input section 606 a touch screen, a touch panel, a keyboard, a mouse, a camera, a microphone, an accelerometer, a gyroscope, etc. The output section 607 includes, for example, Liquid crystal display (LCD), speakers, vibrator, etc. The storage section 608 includes for example, a magnetic tape, a hard disk, etc. The communication section 609 may allow the electronic device 600 to perform wireless or wired communication with other devices to exchange data. Although FIG. 3 illustrates an electronic device 600 including various devices, it should be understood that the embodiment is not required to have all the illustrated devices. The embodiment may be implemented alternatively or provided with more or fewer devices.

In particular, according to the embodiments of the present disclosure, the process described above with reference to the flowchart may be implemented as a computer software program. For example, the embodiments of the present disclosure include a computer program product, which includes a computer program carried on a non-transitory computer readable medium. The computer program contains program code for executing the method shown in the flowchart. In such an embodiment, the computer program may be downloaded and installed from the network through the communication section 609, or installed from the storage section 608, or installed from the ROM 602. When the computer program is executed by the processing section 601, the above-mentioned functions defined in the method embodiments of the present disclosure are executed.

It should be noted that the above-mentioned computer-readable storage medium in the present disclosure may be a computer-readable signal medium or a computer-readable storage medium or any combination of the two. The computer-readable storage medium may be, for example, but not limited to, an electrical, magnetic, optical, electromagnetic, infrared, or semiconductor system, apparatus, or device, or a combination of any of the above. More specific examples of computer-readable storage medium may include, but are not limited to: electrical connections with one or more wires, portable computer disks, hard disks, random access memory (RAM), read-only memory (ROM), erasable Programmable read-only memory (EPROM or flash memory), optical fiber, portable compact disk read-only memory (CD-ROM), optical storage device, magnetic storage device, or any suitable combination of the above. In the present disclosure, the computer-readable storage medium may be any tangible medium that contains or stores a program, and the program may be used by an instruction execution system, apparatus, or device, or used in combination therewith. In the present disclosure, the computer-readable signal medium may include a data signal propagated in a baseband or as a part of a carrier wave, and a computer-readable program code is carried therein. This propagated data signal may take many forms, including but not limited to electromagnetic signals, optical signals, or any suitable combination thereof. The computer-readable signal medium may also be any computer-readable medium other than the computer-readable storage medium mentioned above. The computer-readable signal medium may send, propagate, or transmit a program for use by an instruction execution system, apparatus, or device, or for use in conjunction therewith. The program code in the computer-readable medium may be transmitted by any suitable medium, including but not limited to wire, optical cable, RF (radio frequency), etc., or any suitable combination of the above.

In some embodiments, the client and the server may communicate with any currently known or future-developed network protocol such as HTTP (Hyper Text Transfer Protocol), and may be interconnected with any form or medium of digital data communication (for example, a communication network). Examples of communication networks include local area networks (“LAN”), wide area networks (“WAN”), the Extranet (for example, the Internet), and end-to-end networks (for example, ad hoc end-to-end networks), as well as any currently known or future research and development network of.

The above-mentioned computer-readable medium may be included in the above-mentioned electronic device; or it may exist alone without being assembled into the electronic device.

The aforementioned computer-readable medium carries one or more programs, and when the aforementioned one or more programs are executed by the electronic device, the electronic device performs the following steps: obtaining a mesh model corresponding to each part of the game character, when a triggering operation for changing the game character's equipment is detected; determining, according to the triggering operation for the changing equipment, equipment texture and equipment data corresponding to each part; obtaining a combined game character, by combining mesh models and equipment textures corresponding to respective parts based on the equipment data; and rendering the combined game character.

One or more programming languages or a combination thereof may be used to write computer program codes for performing the operations of the present disclosure. The above-mentioned programming languages include but are not limited to: object-oriented programming languages-such as Java, Smalltalk, C++, and include conventional procedural programming languages-such as “C” language or similar programming languages. The program codes may be executed entirely on the user's computer, partly on the user's computer, executed as an independent software package, partly executed on the user's computer, and partly executed on a remote computer, or entirely executed on a remote computer or server. In case of a remote computer, the remote computer may be connected to the user's computer through any kind of network, including a local area network (LAN) or a wide area network (WAN), or it may be connected to an external computer (for example, using an Internet service provider and through Internet connection).

The flowcharts and block diagrams in the figures illustrate the possible implementation architecture, functions, and operations of the system, method, and computer program product according to various embodiments of the present disclosure. In this regard, each block in the flowchart or block diagram may represent a module, program segment, or part of code, and the module, program segment, or part of the code contains one or more executable instructions for realizing the specified logic function. It should also be noted that, in some alternative embodiments, the functions marked in the block may also occur in a different order from the order marked in the figures. For example, two adjacent blocks may be executed substantially in parallel, or they may sometimes be executed in a reverse order, depending on the functions involved. It should also be noted that each block in the block diagram and/or flowchart, and a combination of blocks in the block diagram and/or flowchart, may be implemented by a dedicated hardware-based system that performs the specified function or operation, or they may be implemented by a combination of dedicated hardware and computer instructions.

The modules or units described in the embodiments of the present disclosure may be implemented in software or hardware. Here, the name of a module or unit does not constitute a limitation on the unit itself under certain circumstances.

The functions described hereinabove may be performed at least in part by one or more hardware logic parts. For example, without limitation, exemplary types of hardware logic parts that may be used include: Field Programmable Gate Array (FPGA), Application Specific Integrated Circuit (ASIC), Application Specific Standard Product (ASSP), System on Chip (SOC), Complex Programmable Logical device (CPLD), or the like.

In the context of the present disclosure, a machine-readable medium may be a tangible medium, which may contain or store a program for use by or in combination with the instruction execution system, apparatus, or device. According to one or more embodiments of the present disclosure, the present disclosure provides a computer-readable medium for storing computer instructions. When the computer instructions are executed on a computer, the computer may execute the game character rendering method of the present disclosure.

The above description is some embodiments of the present disclosure and the illustration of the applied technical principles. Those skilled in the art should understand that the disclosed scope involved in the present disclosure is not limited to the technical solutions formed by specific combination of the above technical features, rather, it should also include other technical solutions formed by arbitrarily combining the above technical features or their equivalent features without departing from the above disclosed concept. For example, technical solutions formed by replacing the above-mentioned features with the technical features disclosed in the present disclosure (but not limited to) with similar functions may also be covered herein.

In addition, although the operations are depicted in a specific order, this should not be understood as requiring these operations to be performed in the specific order shown or in sequence. Under certain circumstances, multitasking and parallel processing may be advantageous. Likewise, although several specific implementation details are included in the above discussion, these should not be construed as limiting the scope of the present disclosure. Certain features that are described in the context of separate embodiments may also appear in combination in a single embodiment. Conversely, various features described in the context of a single embodiment may also appear in multiple embodiments individually or in any suitable sub-combination.

Although the subject matter has been described in a language specific to structural features and/or method logical actions, it should be understood that the subject matter defined in the appended claims is not necessarily limited to the specific features or actions described above. Rather, the specific features and actions described above are merely exemplary forms of implementing the claims.

1. A game character rendering method, comprising:
obtaining a mesh model corresponding to each part of the game character, when a triggering operation for changing the game character's equipment is detected;
determining, according to the triggering operation for the changing equipment, equipment texture and equipment data corresponding to each part;
obtaining a combined game character, by combining mesh models and equipment textures corresponding to respective parts based on the equipment data; and
rendering the combined game character.

2. The method of claim 1, wherein obtaining the mesh model corresponding to each part of the game character comprises:
obtaining a mesh model corresponding to each part, by dividing the mesh model corresponding to the game character according to respective parts.

3. The method of claim 1, further comprising:
obtaining bone structure information and bone dynamic information of the game character; and
determining a combined dynamic game character based on the bone structure information and the bone dynamic information.

4. The method of claim 3, wherein rendering the combined game character comprises: rendering the combined dynamic game character.

5. The method of claim 1, wherein the equipment data comprises size and offset of equipment texture corresponding to the respective part; and
obtain a combined game character, by combining the mesh models and the equipment textures corresponding to the respective parts based on the equipment data comprises:
combining the mesh models corresponding to the respective parts,
combining, according to the size and offset of the equipment textures, the equipment textures corresponding to the respective parts, and
combining the combined mesh models and the combined equipment textures.

6. The method of claim 1, wherein a format of the mesh model corresponding to the respective part comprises one of Gltf format and fbx format.

7. The method of claim 3, wherein a format of the bone structure information and the bone dynamic information comprises one of Gltf format and fbx format.

8. (canceled)

9. An electronic device, comprising:
one or more processors; and
a memory configured to store one or more application programs;
wherein, the one or more application programs are configured, when executed by the one or more processors, to implement the game character rendering method comprising:
obtaining a mesh model corresponding to each part of the game character, when a triggering operation for changing the game character's equipment is detected;
determining, according to the triggering operation for the changing equipment, equipment texture and equipment data corresponding to each part;
obtaining a combined game character, by combining mesh models and equipment textures corresponding to respective parts based on the equipment data; and
rendering the combined game character.

10. A non-transitory machine-readable medium storing processor-executable instructions which, when executed by a processor, cause the a processor to performs comprising:
obtaining a mesh model corresponding to each part of the game character, when a triggering operation for changing the game character's equipment is detected;
determining, according to the triggering operation for the changing equipment, equipment texture and equipment data corresponding to each part;
obtaining a combined game character, by combining mesh models and equipment textures corresponding to respective parts based on the equipment data; and
rendering the combined game character.

11. The method of claim 2, further comprising:
obtaining bone structure information and bone dynamic information of the game character; and
determining a combined dynamic game character based on the bone structure information and the bone dynamic information.

12. The method of claim 11, wherein rendering the combined game character comprises: rendering the combined dynamic game character.

13. The method of claim 11, wherein a format of the bone structure information and the bone dynamic information comprises one of Gltf format and fbx format.

14. The method of claim 2, wherein the equipment data comprises size and offset of equipment texture corresponding to the respective part; and
obtaining a combined game character, by combining the mesh models and the equipment textures corresponding to the respective parts based on the equipment data comprises:
combining the mesh models corresponding to the respective parts,
combining, according to the size and offset of the equipment textures, the equipment textures corresponding to the respective parts, and
combining the combined mesh models and the combined equipment textures.

15. The method of claim 2, wherein a format of the mesh model corresponding to the respective part comprises one of Gltf format and fbx format.
